(19) United States
(12) Patent Application Publication
(10) Pub. No.: US 2008/0151039 A1
(43) Pub. Date: Jun. 26, 2008

(54) On-Screen Relief Viewing Method and Device

(76) Inventors: Dalila Morales, Louverne (FR); Michel Ruffa, Paris (FR)

Correspondence Address: BLANK ROME LLP, 600 NEW HAMPSHIRE AVENUE, N.W., WASHINGTON, DC, 20037, US

(21) Appl. No.: 11/658,081

(22) PCT Filed: Jul. 22, 2005
(86) PCT No.: PCT/FR05/01906

§ 371 Date: Feb. 13, 2008

(30) Foreign Application Priority Data
Jul. 22, 2004 (FR) 0408127

(51) Int. Cl. H04N 7/00; H04N 13/00

(52) U.S. Cl. 348/36; 348/42; 348/E07.091; 348/E13.001

(57) ABSTRACT

The invention relates to a system for viewing stereoscopic and panoramic images, comprising a display screen and a means for the sequential masking of the display screen in order to enable the screen to be viewed selectively by an observer using only one eye. The invention is characterised in that the masking means consists of a transparent support comprising at least one diffraction grating which forms a virtual image of an opaque mask having a transparent window which is perpendicular to the observation axis and which is positioned in a plane parallel to the display screen. The width of the window and the position of the plane in which it is formed are determined such as to enable the entire width of the display screen to be seen using only one eye. The inventive system also comprises control means for changing the position of the virtual image of the window in the plane synchronously with the change in the displayed image.

The present invention relates to the field of image reproduction allowing a spectator to perceive an impression of depth, without the use of special glasses.

Different solutions for the viewing of stereoscopic images are known in the state of the art.

A first solution, which is quite old, involves presenting each eye with a different image, for example using observation equipment that ensures the separation of two simultaneously viewed images. This equipment only allows individual observation, based on image media which have been specially prepared for the adapted observation equipment.

Holography is another known method for recording images which enable three-dimensional reproduction of an object using the interference produced by two coherent light beams, usually generated by a laser. The coding of the phase thus recorded on the photographic plate then allows such an interferometric reconstruction.

One of the techniques requires the object to be materially present at the time of exposure, and the dimensions of the former cannot exceed those of the photographic medium. A second technique, the stereogram, bypasses this constraint by combining stereoscopy and holography. Indeed, by transferring a series of two-dimensional photographs of the object taken in accordance with certain shooting angle conditions, it is then possible to integrate them. sequentially, one by one, to create a complete hologram thanks to an optical slit, an integral part of the hologram, which leads to natural right eye/left eye selection of said images. During its manufacture, the use of a liquid crystal display enables easy manipulation of different images, particularly such as to obtain colour and/or animated stereograms.

Patent U.S. Pat. No. 5,712,732 is particularly known, which describes an auto-stereoscopic image display device comprising at least two perspective views of a scene, comprising a light source; a spatial light modulator (SLM) comprising a plurality of intermediate light modulation elements between an observer and the light source; and means for structuring the light in such a way that a first perspective view of the scene is observed by one of the observer's eyes and the second perspective view of the scene is observed by the observer's other eye, characterised in that said light structuring means comprise a light concentration arrangement, disposed between the light source and the SLM and comprising convergent optical elements which form, in an interlaced manner for the views of the image, a set of vertically separated light concentrations for each view, substantially mapped on a respective set of SLM elements.

This solution requires the use of very expensive electro-optical equipment.

The invention relates more particularly to the device allowing three-dimensional images to be displayed on a computer or television screen, capitalising on the optical characteristics of this second technique.

In this way, the invention enters a domain where other methods for three-dimensional on-screen viewing exist, in particular stereoscopic methods using electronic shutter glasses, or filter glasses (mainly red/green) or even methods using lenticular networks affixed to the screen, which use precision cutting of different angular takes of a same representation.

The invention aims to solve the drawbacks of the solutions of the prior art by doing away with the inconvenience of having to wear glasses in current methods, and with the stereoscopic (or panoramic) cutting of images, which is necessary when using a lenticular network, knowing that the latter limits the optimal field of view and is detrimental to the quality of the three-dimensional images.

The invention also aims to allow relief viewing of images (animated or not) in stereoscopic or panoramic view, based on the stereoscopic effect, without using glasses and without having to cut or fragment the images. By means of the invention, each of the observer's eyes can see the same overall image separately, each one viewing it from an appropriate angle, which provides a three-dimensional effect with a field of vision that can vary according to the manner in which the holographic window, which is the object of this invention and which allows this visualisation, is used.

To this effect, the invention in its broadest sense relates to a system for viewing stereoscopic and panoramic images comprising a display screen and means for sequential masking of the display screen in order to enable the screen to be viewed selectively by an observer using only one eye, characterised in that the masking means consist of a transparent medium comprising at least one diffraction grating which forms a virtual image of an opaque mask having a transparent window which is perpendicular to the observation axis and which is positioned in a plane parallel to the display screen, the width of the window and the position of the plane in which it is formed being determined such as to enable the entire width of the display screen to be seen using only one eye, the system also comprising control means for changing the position of the virtual image of the window in the plane synchronously with the change in the displayed image.

The device which is the object of the invention enables three-dimensional viewing on a screen and it is made up of a hologram which is visible in white light from a virtual slit, in other words a vertical transparent holographic window on a luminous background, in transversal movement in front of it. A single eye is able to view the image on the screen, while the other only sees a luminous background which serves as a mask. The transversal movement of the holographic slit can be caused by a change in the lighting angle of the hologram.

Thus, within the framework of stereoscopic vision, pairs of images in a sequence appear on the screen, and thanks to the lighting device of the transparent holographic plate, the virtual slit moves synchronously with the image pairs so that the right image appears on the screen when the holographic window is located in front of the right eye and the left image appears on the screen when the holographic window is located in front of the left eye. In this case, the width of the slit is ideally equal to half the width of the screen. Thanks to retinal persistence, the observer unconsciously integrates the two images, obtaining a three dimensional view.

In the case of panoramic vision, the slit is narrower and the number of points of view is greater. The number of images and the speed at which they appear is increased.

Hologram lighting can be provided by an “array” of electric arc lamps, or with a halogen lamp assisted by a pivoting mirror, guided by the clock of the computer itself, the light of which is reflected off the hologram thanks to an array of mirrors, judiciously oriented, placed cantilevered in front of the screen.

Said animated images are advantageously made up of right and left image pairs.

The invention preferably comprises at least two sources of white light illuminating the medium, each causing the formation of one of the windows.

According to a specific embodiment of the invention, the masking means consist of a holographic screen applied to a display unit (cathode-ray tube, LCD, CCD or other).

According to another specific embodiment of the invention, the masking means consist of a holographic medium other than silver.

This masking means advantageously consist of a system which uses transversal scanning of the illumination of a holographic plate in order to allow synchronous movement of a frontal optical window.

According to another variation, the masking means consist of a holographic medium which is illuminated by transmission.

These masking means advantageously consist of a holographic medium which is illuminated by reflection.

According to a specific embodiment of the invention, the masking means consist of a holographic medium forming a luminous holographic image.

The stereoscopic and panoramic image viewing system is characterised in that the masking means are activated by illumination other than from a white light source (laser, LED, monochromatic or polychromatic sources).

According to an alternative, the masking means are activated by a mechanical or electronic system of scanning a light source (arrays of flash bulbs, CCD arrays used as electronic light shutters, pivoting mirrors, rotating prisms).

The system according to the invention therefore consists of:
A vertical holographic window created by means of a hologram on a silver medium or another transparent holographic medium, placed in front of the screen. All it takes to create this optical slit is a rectangular plate master (which can be reflective or very diffusive, according to the optical geometry used for its creation) on which a black vertical band is placed. Optical geometry for creating reflection holograms is used.
An optical system for lighting said hologram by scanning, allowing said window to move in front of the screen along the horizontal axis.
Computer processing of the images so that the different stereoscopic and panoramic takes move in a synchronous manner with the holographic window, at a speed that ensures retinal persistence.

The invention is described below in greater detail in reference to the appended drawings in which:

FIG. 1 shows the creation of the holographic master of the holographic window.

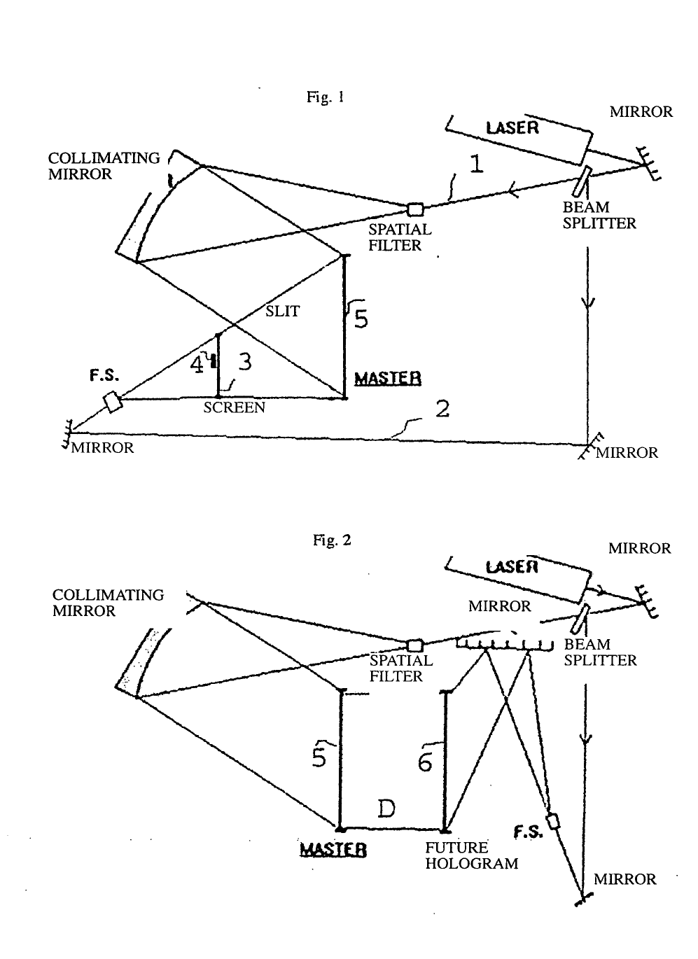

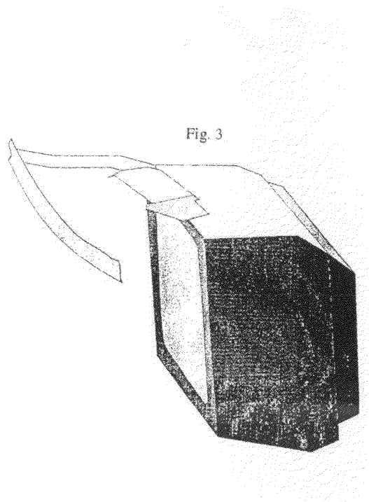

FIG. 2 shows the creation of the holographic transfer of the holographic window in order for it to be visible in white light.

FIG. 3 shows the device for lighting said window by scanning of when it is used in front of the computer (or television) screen.

### CREATION OF THE HOLOGRAPHIC WINDOW MASTER.

The first step involves obtaining a master, as described (FIG. 1). The master is the original image created using laser light and only visible with the latter. The method of obtaining said master is known.

In this geometry, the object beam 2 illuminates a diffusing rectangular panel 3 made from frosted glass or tracing paper, on which a vertical black band 4 of predetermined thickness is placed. It can be wider or narrower in inverse proportion to the number of panoramic views to be used, and takes up half the panel if stereoscopic images are required. Its width is never less than the diameter of the pupil of an eye. The beam, with reference 1, illuminates the master holographic plate directly.

### Creation of a Hologram which is Visible in While Light (Transferring the Master)

The master is projected onto the future hologram 6 in one go. In fact, this step involves the creation of a hologram from a hologram. If this is the final stage, once the hologram is developed, the image is monochrome, the colour being defined by the chemical development. A polychromatic hologram can be obtained using known techniques. The medium is still transparent.

The reflection hologram 6 medium is transparent, and when it is lit by a beam from a point source of white light, the resulting image is a luminous background covering the entire surface of the medium, except for a vertical band, which is transparent. This band floats several dozen centimetres in front of the medium. The distance is that used during the creation of the transfer, namely D. This holographic medium 6 can be placed on the screen of a computer or television set.

According to the geometry used for creating the hologram, the lighting angle is around 45° at the time of reproduction, which places the source several centimetres in front of the hologram, above or below. As regards positioning along the horizontal parallax of the optical window that appears, it varies according to the horizontal parallax given to the light source.

### Light Device

For a quick scan of the holographic plate by the point source of light along its horizontal parallax, it is easy to materialise the optical window sequentially in different positions. The eye is only able to observe the entire contents of the display monitor through this window. That observed by the left eye and right eye is never the same at any given time, since the images that appear on the screen are sequential and, in a synchronous manner with the scanning of the window, shots of the same object, animated or not, from different angles. The scanning must be fast enough for there to be retinal persistence. The light source can be scanned by a double refracting crystal or a mobile mirror, placed at the output thereof. A frontal mirror distributes the light over the entire hologram. The entire hologram is scanned at least 24 times per second and is electronically synchronised with the images on the screen.

1. System for viewing stereoscopic and panoramic images comprising;
a display screen and means for sequential masking of the display screen in order to enable the screen to be viewed selectively by an observer using only one eye, characterised in that the masking means comprises a transparent medium comprising at least one diffraction grating which forms a virtual image of an opaque mask having a transparent window which is perpendicular to the observation axis and which is positioned in a plane parallel to the display screen, the width of the window and the position of the plane in which it is formed being determined such as to enable the entire width of the display screen to be seen using only one eye; and
control means for changing the position of the virtual image of the window in the plane synchronously with the change in the displayed image.

2. System for viewing stereoscopic and panoramic image according to claim 1, characterised in that said animated images are made up of left and right image pairs.

3. System for viewing stereoscopic and panoramic images according to claim 1, wherein at least two sources of white light are used for illuminating the medium, each causing the formation of one of the windows.

4. System for viewing stereoscopic and panoramic images according to claim 1, wherein the masking means comprises a holographic screen applied to a display unit.

5. System for viewing stereoscopic and panoramic images according to claim 1, wherein the masking means comprises a holographic medium other than silver.

6. System for viewing stereoscopic and panoramic images according to claim 1, wherein the masking means comprises a system which uses transversal scanning of the illumination of a holographic plate in order to allow synchronous movement of a frontal optical window.

7. System for viewing stereoscopic and panoramic images according to claim 1, wherein the masking means comprises a holographic medium which is illuminated by transmission.

8. System for viewing stereoscopic and panoramic images according to claim 1, wherein the masking means comprises a holographic medium which is illuminated by reflection.

9. System for viewing stereoscopic and panoramic images according to claim 1, wherein the masking means comprises a holographic medium forming a luminous holographic image.

10. System for viewing stereoscopic and panoramic images according to claim 1, wherein the masking means is activated by illumination other than from a white light source.

11. System for viewing stereoscopic and panoramic images according to claim 1, wherein the masking means is activated by a mechanical or electronic system of scanning a light source.

12. System for viewing stereoscopic and panoramic images according. to claim 4, wherein the display unit is one of a cathode-ray tube, LCD, and CCD.

13. System for viewing stereoscopic and panoramic images according to claim 10, wherein the white light source is one of a laser, LED, monochromatic emitter, and polychromatic emitter.

14. System for viewing stereoscopic and panoramic images according to claim 11, wherein the light source is one of an array of flash bulbs, array of CCD used as electronic light shutters, pivoting mirrors, and rotating prisms.
